(19) United States
(12) Patent Application Publication
(10) Pub. No.: US 2026/0347204 A1
(43) Pub. Date: Nov. 5, 2026

(54) Hydrothermal Production of Lithium Manganese Iron Phosphate in a Continuous Process

(71) Applicant: TDA Research, Inc., Golden, CO (US)

(72) Inventors: Girish Srinivas, Broomfield, CO (US); Vinh T. Nguyen, Arvada, CO (US); Steven Dietz, Englewood, CO (US)

(73) Assignee: TDA Research, Inc., Golden, CO (US)

(21) Appl. No.: 19/736,070

(22) Filed: Jul. 9, 2026

Related U.S. Application Data
(62) Division of application No. 18/424,337, filed on Jan. 26, 2024.

(51) Int. Cl. C01G 49/00

(52) U.S. Cl. CPC C01G 49/009; C01P 2002/01; C01P 2002/72; C01P 2004/04; C01P 2004/51; C01P 2006/40

(57) ABSTRACT

A continuous hydrothermal process for producing LFP/LMFP cathode materials for lithium-ion batteries. The reactant solutions include: (1) a lithium precursor (LiOH) and a carbon source (15 wt % sucrose); (2) an iron precursor (FeSO₄) and a phosphorus precursor (H₃PO₄); and in the case of LMFP, a manganese precursor (MnSO₄) and a surfactant in solution 2. Reactant solutions are fed into a series of one or more continuous stirred tank reactors (CSTRs) at a constant flowrate. Active LFP/LMFP flows out of the CSTRs and into a collection tank, where it is cooled and depressurized. The product flows into a slurry tank, then a centrifugal separator to remove aqueous waste. The LFP/LMFP is transferred to a continuous rotary kiln for drying and sintering, and the carbon coating forms. The disclosed processes produce LFP/LMFP with small average particle size, high purity, high capacity, and high yield without any ball-milling or sieving steps.

### STATEMENT OF GOVERNMENT INTEREST

This invention was made at least in part under funding from the United States Government, Defense Logistics Agency contract #SP4701-21-P-0073 and #SP4701-22C-0092. The government has certain rights in the invention.

### REFERENCE TO RELATED APPLICATIONS

The present application claims the benefit of the application Ser. No. 18/424,337, which is incorporated by reference herein in its entirety.

### BACKGROUND OF THE INVENTION

Rechargeable lithium-ion batteries (LIBs) were first commercialized in the early 1990s and are now one of the major power storage solutions; they are used in portable electronics, electric vehicles, and renewable energy storage systems. The major advantages of rechargeable LIBs are their high energy density and excellent cycling performance. Rechargeable LIBs are found in almost all daily use electronics, including smart phones, laptops, power tools and toys. Many weapons now depend on LIBs to power their systems. Unfortunately, the US military is particularly vulnerable to supply shortages of the active components needed for LIBs because virtually all the large-scale production of electrode materials is done in China. In addition, many types of LIBs also incorporate cobalt. Cobalt is expensive, the supply is limited, and shortages are expected as electric vehicle sales grow. Possible shortages of this one mineral or disruption in the supply chain, of which 59% originates in the Democratic Republic of the Congo, have the potential to disrupt LIB production. As a result, there is a great need for cathode materials that are cobalt free, readily available in the US and that are safe and inexpensive.

While there are several cathode materials in use (almost half of which incorporate cobalt), lithium iron phosphate LiFePO4 (LFP) is showing significant growth in the energy storage and the electric vehicle market. The main reason is cost; cobalt is expensive and scarce while iron is abundant and inexpensive. Furthermore, LFP is non-toxic and environmentally benign. Lithium manganese iron phosphate (LMFP) is another similar cathode material, essentially LFP with manganese present in place of some of the iron. Alternatively, there could be cobalt or nickel in place of some of the iron, or combinations of all three (Mn, Co, Ni). LMFP batteries have the advantage of achieving a higher energy density than LFP.

LFP and LMFP powders can be prepared by both solid-state and solution-based methods. Solid-state techniques are carried out at high temperatures without the addition of any solvent. On the other hand, solution-based methods are based on reactions that take place in the presence of appropriate solvent systems. Solid state synthesis is the conventional method for preparing LFP and LMFP. These processes are costly and involve several mixing, grinding, and heating stages. Although solid state methods are simple to use, they are typically time and energy consuming and often lead to large, non-uniform, and non-crystalline particles, low purity products, and deliver relatively poor electrochemical performance. Therefore, solution-based methods are of increasing importance as they often result in smaller and more uniform particle sizes, higher purity, more homogeneous carbon coatings and higher electrochemical capacity (Satyavani et al. 2016). These methods are also easier to scale up, faster for production, and more economical than solid-state approaches.

Hydrothermal synthesis is a chemical process that occurs in an aqueous solution of mixed precursors above the boiling temperature of water. Solvothermal is similar but uses an organic solvent instead of water (Wang et al. 2013). In either method, it is possible to avoid the calcination step and obtain pure LFP/LMFP powders directly from the heated solution. However, the low temperature product does not give good cathode capacity and a short calcining step in inert gas is needed to carbonize the carbon source and reduce any iron(III) to iron(II) (Martins et al. 2017, Jun et al. 2017). During the synthesis, heated solvent accelerates the diffusion of particles, and the crystal growth is relatively fast. Hydrothermal/solvothermal synthesis is typically carried out in an autoclave, and there are less environmental concerns than many other powder production technologies. Therefore, hydrothermal synthesis is a simple, clean, and relatively low-cost method that can be used to produce powders with high uniformity and purity.

Hydrothermal/solvothermal synthesis starts with the mixing of precursors at an exact stoichiometric ratio. After the homogeneous mixing of the precursors, the solution is treated in an autoclave at a temperature greater than 100 °C, generally between 120 and 220 °C for 5-10 hours. LFP powders can then be obtained by filtration or drying the slurries. However, in this case an additional heat treatment (or calcination) step needs to be carried out at elevated temperatures of 400-750 °C for 0.5-12 hours under N₂ or argon atmosphere to carbonize the carbon source. Carbon sources used include sugar, ascorbic acid, and carbon black which act as the reducing agents to prevent the oxidation of Fe(II) during calcination (Chen and Whittingham 2006).

Currently, solution-based methods are done in batch processes. Batch processing is inefficient and labor intensive because it involves opening the reactor to load ingredients, heating the reactor to do the reaction, and then waiting for it to cool down before it can be emptied and reloaded again. Any large-scale manufacturing is done as a continuous process because continuous processing can reduce operating expenses by at least 90% and capital expenses by at least 50% (Subramanian 2015). This is because the process continually feeds reactants into the reactor and remove product without any changes in temperature and pressure.

There is a need to streamline synthesis procedures for battery electrode materials to a continuous process, while maintaining high uniformity and purity of the products. There is also a need to improve those cathode materials which rely on less expensive, environmentally friendly, and locally sourced minerals (rather than cobalt). An improved production method is needed which is sufficiently efficient and economical, and produces high-capacity electrode materials in the US.

### SUMMARY OF THE INVENTION

To overcome limitations of the prior art, the present disclosure provides a continuous hydrothermal process to make LFP or LMFP electrode materials for use in LIBs. The process can run 24/7 and the size of the reactor is much smaller than what is needed to make the same amount of product in a batch process. Further, the continuous process produces a far more consistent product. To develop the continuous process to produce LFP or LMFP, a one-pot process using a solution-based direct production method has been optimized in a continuous manner using continuously stirred tank reactors (CSTRs) followed by post heat treatment using a continuous rotary kiln. FIG. 1 shows a flowchart comparison of the present continuous hydrothermal synthesis method versus prior solid-state methods of LFP synthesis.

The disclosed method produces LFP which has higher capacity than commercial LFP. The LFP produced by the disclosed method also contains uniformly small particles (30-40 nm) and smaller agglomerates (3-6 micron). The process produces high purity LFP by XRD (>99%) with high capacity (>155 mAh/g) at high yields (>95%).

A benefit to the continuous hydrothermal method for producing LFP/LMFP is that there is no need to mill or sieve the produced material before electrode formation. Another benefit is the continuous processing which can greatly reduce operating expenses in battery production facilities. The method for producing LFP/LMFP produces high quality cathode materials at a faster rate, with less energy use, and with less involved labor than current processes for making similar product.

The disclosure provides a continuous hydrothermal process for making lithium iron phosphate (LFP) comprising the steps: providing a first reactant solution in a first feed vessel and providing a second reactant solution in a second feed vessel; pumping the first reactant solution from the first feed vessel and the second reactant solution from the second feed vessel into one or more continuous stirred tank reactors (CSTRs) in series, wherein: the first reactant solution comprises a lithium precursor and a carbon source in a first solvent; the second reactant solution comprises an iron precursor and a phosphorus precursor in a second solvent; the first feed vessel and the second feed vessel are operably connected to the at least one CSTR by at least one high pressure pump, wherein, if two or more CSTRs are used each CSTR is operably connected in series; and, the first reactant solution and the second reaction solution are fed into the at least one CSTR at a molar ratio of x:y:z of lithium precursor to iron precursor to phosphorus precursor, wherein x is 3±0.3, y is 1±0.1, and z is 1±0.1; providing a collection tank operably connected to an exit of the CSTR or an exit of the series of CSTRs; collecting a reaction product in the collection tank; wherein the above steps are operated in a continuous process.

The continuous hydrothermal process may further comprise the steps: cooling and depressurizing the reaction product in the collection tank; draining the reaction product into a slurry tank connected to an exit of the collection tank, wherein the slurry tank agitates an LFP slurry from the reaction product; feeding the LFP slurry into a centrifugal separator connected to an exit of the slurry tank; separating and removing any liquid reactor waste from the LFP slurry, leaving only an LFP product; and, drying and sintering the LFP product in a continuous rotary kiln; wherein, all of the steps from pumping the reactant solutions until drying and sintering the LFP product in the continuous rotary kiln are operated in a continuous process.

In a more preferred embodiment, the first reactant solution and the second reaction solution are fed into the at least one CSTR at a molar ratio of x:y:z of lithium precursor to iron precursor to phosphorus precursor, wherein x is 3±0.15, y is 1±0.05, and z is 1±0.05. In a most preferred embodiment, the first reactant solution and the second reaction solution are fed into the at least one CSTR at a molar ratio of x:y:z of lithium precursor to iron precursor to phosphorus precursor, wherein x is 3±0.03, y is 1±0.01, and z is 1±0.01.

In one embodiment, the one or more CSTRs in series comprises 3 CSTRs. In this embodiment, the residence time of the first reactant solution and the second reactant solution is 1-3 hours through all 3 CSTRs (meaning 20 minutes to 1 hour residence time per each CSTR). In an embodiment, the first reactant solution and the second reactant solution are flowing through the one or more CSTRs in series at a steady flowrate.

In a preferred embodiment, the lithium precursor is LiOH, the iron precursor is FeSO₄, and the phosphorus precursor is H₃PO₄. The lithium precursor and carbon source are in the first solvent, which may comprise water, consist essentially of water, consist of a majority water, or be water. The iron precursor and phosphorus precursor are in the second solvent, which also may comprise water, consist essentially of water, consist of a majority water, or be water. Preferably, the carbon source is a sugar. More preferably, the carbon source is sucrose, which is added at 10-20 weight % of the theoretical yield of the LFP product. Most preferably, the carbon source is sucrose and is added at 15 weight % of the theoretical yield of the LFP product.

In an embodiment of the continuous hydrothermal process for making LFP, the one or more CSTRs in series are purged with an inert gas, maybe nitrogen, before pumping the first reactant solution from the first feed vessel and the second reactant solution from the second feed vessel into the one or more CSTRs in series. Preferably, the one or more CSTRs in series are operated at 120-220 °C. At these temperatures, the one or more CSTRs in series are preferably kept at a sufficiently high pressure so the first reactant solution and the second reactant solution remain in liquid phase. In one embodiment, the one or more CSTRs in series are operated at 180 °C. At 180 °C, the one or more CSTRs are preferably operated at a pressure of at least 150 psig. More preferably, they are operated at a pressure of at least 200 psig.

In an embodiment, the collection tank further comprises at least one level sensor on an inner side of the collection tank, and the at least one level sensor activates draining the reaction product into the slurry tank connected to the exit of the collection tank.

In an embodiment, the sintering step comprises using a continuous rotary kiln to sinter the LFP product under nitrogen at 400-750 °C, for 2-4 hours. More preferably, the continuous rotary kiln sinters the LFP product at 600 °C for 2.5 hours. Preferably, the process does not comprise any ball-milling steps or any sieving steps. The process may produce an LFP product having an average particle size of 30-40 nm, a purity of more than 99%, a capacity of more than 155 mAh/g, and a yield of more than 95%.

The disclosure also provides an LFP powder product made by the described continuous hydrothermal process. Preferably, the LFP powder product has a purity of more than 99%, a capacity of more than 155 mAh/g, a yield of more than 95%, an average particle size of 30-40 nm, a carbon coating thickness of 1-6 nm, and a density of 3.94-4.04 g/cm³.

The disclosure provides a continuous hydrothermal process for making lithium manganese iron phosphate (LMFP) comprising the steps: providing a first reactant solution in a first feed vessel and providing a second reactant solution in a second feed vessel; pumping the first reactant solution from the first feed vessel and the second reactant solution from the second feed vessel into one or more continuous stirred tank reactors (CSTRs) in series, wherein: the first reactant solution comprises a lithium precursor and a carbon source in a first solvent; the second reactant solution comprises a manganese precursor, an iron precursor and a phosphorus precursor in a second solvent; the first feed vessel and the second feed vessel are operably connected to the at least one CSTR by at least one high pressure pump, wherein, if two or more CSTRs are used each CSTR is operably connected in series; and, the first reactant solution and the second reaction solution are fed into the at least one CSTR at a molar ratio of w:x:y:z of lithium precursor to manganese precursor to iron precursor to phosphorus precursor, wherein w is 6±0.6, x is 0.1-1.9, y is 0.1-1.9, (x+y) is 2±2, and z is 2±2; providing a collection tank operably connected to an exit of the CSTR or an exit of the series of CSTRs; collecting a reaction product in the collection tank; wherein the above steps are operated in a continuous process.

The continuous hydrothermal process may further comprise the steps: cooling and depressurizing the reaction product in the collection tank; draining the reaction product into a slurry tank connected to an exit of the collection tank, wherein the slurry tank agitates an LMFP slurry from the reaction product; feeding the LMFP slurry into a centrifugal separator connected to an exit of the slurry tank; separating and removing any liquid reactor waste from the LMFP slurry, leaving only an LMFP product; and, drying and sintering the LMFP product in a continuous rotary kiln; wherein, all of the steps from pumping the reactant solutions until drying and sintering the LMFP product in the continuous rotary kiln are operated in a continuous process.

In a more preferred embodiment, the first reactant solution and the second reaction solution are fed into the at least one CSTR at a molar ratio of w:x:y:z of lithium precursor to manganese precursor to iron precursor to phosphorus precursor, wherein w is 6±0.3, x is 0.1-1.9, y is 0.1-1.9, (x+y) is 2±0.1, and z is 2±0.1. In a most preferred embodiment, the first reactant solution and the second reaction solution are fed into the at least one CSTR at a molar ratio of w:x:y:z of lithium precursor to manganese precursor to iron precursor to phosphorus precursor, wherein w is 6±0.06, x is 0.1-1.9, y is 0.1-1.9, (x+y) is 2±0.02, and z is 2±0.02.

Preferably, the continuous hydrothermal process for making LMFP further comprises adding a surfactant to the second reactant solution. In an embodiment, the surfactant is cetyltrimethylammonium bromide (CTAB). Preferably, the surfactant is a sufficient amount of CTAB so the first reactant solution and the second reactant solution in the one or more CSTRs have 0.1 M CTAB.

In one embodiment, the one or more CSTRs in series comprises 3 CSTRs. In this embodiment, the residence time of the first reactant solution and the second reactant solution is 1-3 hours through all 3 CSTRs (meaning 20 minutes to 1 hour residence time per each CSTR). In an embodiment, the first reactant solution and the second reactant solution are flowing through the one or more CSTRs in series at a steady flowrate.

In a preferred embodiment, the lithium precursor is LiOH, the manganese precursor is MnSO₄, the iron precursor is FeSO₄, and the phosphorus precursor is H₃PO₄. The lithium precursor and carbon source are in the first solvent, which may comprise water, consist essentially of water, consist of a majority water, or be water. The manganese precursor, iron precursor, and phosphorus precursor are in the second solvent, which also may comprise ethylene glycol and water. In an embodiment, the second solvent comprises a x:y volumetric ratio of ethylene glycol to water, wherein x is 1±0.1 and y is 1±0.1. Preferably, the carbon source is a sugar. More preferably, the carbon source is sucrose, which is added at 10-20 weight % of the theoretical yield of the LMFP product. Most preferably, the carbon source is sucrose and is added at 15 weight % of the theoretical yield of the LMFP product.

In an embodiment of the continuous hydrothermal process for making LMFP, the one or more CSTRs in series are purged with an inert gas, maybe nitrogen, before pumping the first reactant solution from the first feed vessel and the second reactant solution from the second feed vessel into the one or more CSTRs in series. Preferably, the one or more CSTRs in series are operated at 120-220 °C. At these temperatures, the one or more CSTRs in series are preferably kept at a sufficiently high pressure so the first reactant solution and the second reactant solution remain in liquid phase. In one embodiment, the one or more CSTRs in series are operated at 180 °C. At 180 °C, the one or more CSTRs are preferably operated at a pressure of at least 150 psig. More preferably, they are operated at a pressure of at least 200 psig.

In an embodiment, the collection tank further comprises at least one level sensor on an inner side of the collection tank, and the at least one level sensor activates draining the reaction product into the slurry tank connected to the exit of the collection tank.

In an embodiment, the sintering step comprises using a continuous rotary kiln to sinter the LMFP product under nitrogen at 400-750 °C, for 2-4 hours. More preferably, the continuous rotary kiln sinters the LMFP product at 600 °C for 2.5 hours. Preferably, the process does not comprise any ball-milling steps or any sieving steps.

The disclosure also provides an LMFP powder product made by the described continuous hydrothermal process.

### BRIEF DESCRIPTION OF DRAWINGS

FIG. 1: Flowchart comparison of a) prior method for synthesizing LFP and b) continuous hydrothermal process for synthesizing LFP.

FIG. 2A: Reactor volume required for an arbitrary reaction using one reactor.

FIG. 2B: Reactor volume required for an arbitrary reaction using 3 reactors in series.

FIG. 3: Process flow diagram of continuous hydrothermal process for making LFP.

FIG. 4: General schematic for making LFP.

FIG. 5: X-ray diffraction analysis (XRD) of LFP product using lithium hydroxide, iron sulfate, and phosphoric acid in continuous hydrothermal process.

FIG. 6: Coin cell cycles with LFP cathodes with different sugar loading concentrations.

FIG. 7: Discharge capacity at different sugar loading concentrations.

FIG. 8: Coin cell cycles with LFP cathodes of different sintering times.

FIG. 9: Coin cell cycles with LFP cathodes at different reaction concentrations.

FIG. 10: Coin cell cycles with LFP cathodes made from continual hydrothermal process vs. commercial material

FIG. 11: XRD fittings to calculate LFP crystal size.

FIG. 12A: Distribution of LFP particle sizes in commercial material.

FIG. 12B: Distribution of LFP particle sizes in continuous hydrothermal process material.

FIG. 13A: Transmission electron microscopy (TEM) of carbon coating on LFP particles in thicker locations.

FIG. 13B: Transmission electron microscopy (TEM) of carbon coating on LFP particles in thinner locations.

FIG. 14: XRD of LMFP particles produced by continuous hydrothermal process.

FIG. 15: Capacitance of LMFP from continuous hydrothermal process over many cycles.

FIG. 16: Process flow diagram of continuous hydrothermal process for making LMFP.

FIG. 17: Coin cell cycles with LMFP cathodes of varying reacting times, both with and without added CTAB.

FIG. 18: XRD of LFP product made from continuous hydrothermal process with 3 CSTRs in series.

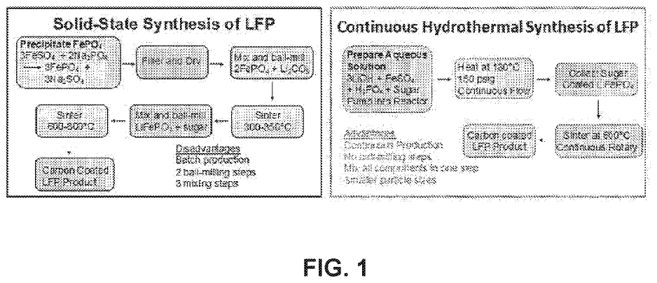

### DETAILED DESCRIPTION OF THE INVENTION

The production of electrode materials for LIBs, in general, is limited by several factors: (i) large-scale production is primarily overseas, which poses a national security issue for supply; (ii) cathode materials are expensive, have limited supply, are found primarily overseas, and/or are environmentally harmful; (iii) production costs are high and/or rely on labor intensive steps; (iv) products contain large, non-uniform, non-crystalline particles; (v) product performance (i.e. capacitance) is inferior.

The present disclosure solves these problems by teaching a method for continuous production of LFP/LMFP powder for use in LIBs which is characterized by uniformly smaller particle sizes, high purity, high capacitance, and high yield of LFP/LMFP.

The term “continuous hydrothermal process” means a method for synthesis which occurs in an aqueous solution of mixed precursors above the boiling temperature of water, and the process involves no breaks or need for manual inputs or switches from the point of beginning the process (turning the system on and allowing the first reactants to mix) to the formation of the final product.

The term “feed vessel” means a tank containing a reactant solution, which is operably connected to the series of CSTRs (one or more) via at least one high pressure pump. The feed vessel must be sufficiently large and composed of a non-reactive and non-degrading material, so the reactants do not risk contamination. The feed vessel should be purged prior to use, maybe with nitrogen, and any extra headspace in the feed vessel should contain an inert gas blanket to prevent oxidizing the reactants. The reactant solution must be made and fed into the feed vessel prior to starting up the system.

The term “one or more CSTRs in series” means multiple CSTRs of equal volume and operated at the same temperature and pressure, operably connected to one another, so reacting fluids flow from a first tank reactor to a second tank reactor, and so on for the full length of the series. Each successive reactor builds on the conversion rate of the previous reactor, as the continuous mixing means that the conversion rate of a first reactor is its rate at exit, which is also the entrance rate for the next reactor.

The term “precursor” means a compound which contains a desired element and dissolves in a chosen reaction solvent to participate in LFP/LMFP production, where the element is a part of the LFP/LMFP structure. For example, a “lithium precursor” may include lithium hydroxide, lithium carbonate, or lithium nitrate. An “iron precursor” may include iron sulfate, iron nitrate, or iron chloride. A “phosphorus precursor” may include phosphoric acid, ammonium dihydrogen phosphate, or diammonium hydrogen phosphate. A “manganese precursor” may include manganese sulfate, manganese carbonate, manganese nitrate, or manganese chloride.

The term “carbon source” means a carbon-containing precursor which can be added to LFP/LMFP reactants and ultimately, via high temperatures, forms a carbon coating around the LFP/LMFP particles, increasing the electrical conductivity of the product. Nonlimiting examples of carbon sources include sugars, sucrose, glucose, ascorbic acid, acetylene black, carbon black, graphene, carbon nanotubes, citric acid, tartaric acid, and other organic and inorganic equivalent carbon sources.

The term “reaction product” means the solution which results from mixing each of the reactant solutions together in the CSTRs. The reaction product contains LFP/LMFP at the correct molar ratio within the solvent of choice, as well as the carbon source which has not yet formed a carbon coating around the LFP/LMFP particles. Also in the solvent may be unreacted starting materials and unwanted by-products which are separated out by solid-liquid separation.

The term “collection tank” means an airtight vessel attached to an outlet in the last CSTR of the series of CSTRs, capable of collecting and storing the reaction product (LFP/LMFP plus the carbon source and any waste in solvent) flowing from the CSTR. The collection tank may have level sensors to activate dispensing of the collection tank's contents into a next vessel. The collection tank may have cooling and depressurizing abilities. The collection tank may be operably connected to a slurry tank in an air-tight, continuous manner.

The term “slurry tank” means a vessel that holds and agitates the solid-liquid mixture of active LFP/LMFP product and solvent waste. It intermittently mixes and agitates the components to feed a homogenized slurry into the centrifugal separator.

The term “LFP slurry” means a mixture of active LFP, carbon source, and reaction wastewater, or solvent which the reactants were initially dissolved and reacted in.

The term “LMFP slurry” means a mixture of active LMFP, carbon source, and reaction wastewater, or solvent which the reactants were initially dissolved and reacted in.

The term “centrifugal separator” means a separation technology which continuously separates liquid and solid. The solid is the desired product, and the liquid constitutes the waste. A centrifugal separator uses the centrifugal force acts essentially an artificial gravity that pushes by-product containing wastewater or solvent out, and dispenses the solid product particles out into a collection vessel operably placed below an exit to the separator. The centrifugal separator is operably connected to the slurry tank.

The term “liquid reactor waste” means the solvent which the reactants were dissolved and reacted in, along with any unreacted materials that may still be dissolved in the solvent, and any unwanted by-products.

The term “LFP product” means only the fully reacted, solid LFP powder (plus carbon source) product produced from the hydrothermal reaction and separated from any liquid waste. This product requires further calcination in order to form the carbon coating required to improve the capacitance of the cathode materials, but does not require any other physical manipulation steps prior to use in an electrode.

The term “LMFP product” means only the fully reacted, solid LMFP powder (plus carbon source) product produced from the hydrothermal reaction and separated from any liquid waste. This product requires further calcination in order to form the carbon coating required to improve the capacitance of the cathode materials, but does not require any other physical manipulation steps prior to use in an electrode.

The term “continuous rotary kiln” means a pyroprocessing device that can raise temperatures to 400-750 °C, preferably at least 600 °C. It must be able to maintain a constant, high temperature for 1-3 hours, preferably at least 2.5 hours.

The term “sufficiently high pressure” means the water-saturation pressure at a given temperature, or a greater pressure.

The term “level sensor” means a device that is capable of detecting, monitoring, and/or measuring the level of liquid in a vessel, which converts the perceived data into an electrical signal. The level sensor is electrically connected to an outlet valve of the collection tank, so when the reaction product reaches a certain height in the collection tank, the level sensor emits a signal which triggers the opening of the valve, and drains the reaction product to the next vessel in the system.

The term “sugar” means a carbohydrate of the general formula C~(H₂O)ₙ, including monosaccharides and polysaccharides. The sugar may be glucose, sucrose, or equivalents.

The term “surfactant” means a compound which decreases the interfacial tension between two liquids, and allows for easier dissolving and mixing of reactants in solvents. Non-limiting examples include quaternary ammonium salts, cetyltrimethylammonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB).

The term “residence time” means the total time spent in all CSTRs, from initial feeding into the first CSTR to exit into the collection tank.

The term “ball-milling steps” means the use of a ball mill, or similar grinders, which work based on impact and attrition to decrease the LFP/LMFP particle size. The lack of these steps indicates that desired small particles sizes are achieved directly from the continuous process without additional grinding, pounding, pressuring, or related manipulations to form small particles.

The term “sieving steps” means the process of removing particles from a mixture based on differences in particle size, perhaps by use of a mesh or perforated plate. Sieving is done when there are larger, unwanted particles present in a final product. The lack of these steps indicates that the LFP/LMFP particles are not only an average desired small size, but also uniform in the sense that larger, coarser particles are not present and do not have to be removed.

LFP contains a stoichiometric ratio of lithium to iron to phosphorus of 3:1:1. Thus, the reactants are ideally fed into the series of CSTRs at this ratio. There is room for error, and excess reactants are collected as waste. The true ratio of lithium precursor to iron precursor to phosphorus precursor may be 3:1:1, 3.3:1:1, 3.2:1:1, 3.15:1:1, 3.1:1:1, 3.05:1:1, 3:03:1:1, 3.01:1:1, 2.99:1:1, 2.97:1:1, 2.95:1:1, 2.9:1:1, 2.85:1:1, 2.8:1:1, 2.7:1:1, 3:1.1:1, 3:1.07:1, 3:1.05:1, 3:1.03:1, 3:1.01:1, 3:0.99:1, 3:0.97:1, 3:0.95:1, 3:0.93:1, 3:0.9:1, 3:1:1.1, 3:1:1.07, 3:1:1.05:1, 3:1:1.03, 3:1:1.01, 3:1:0.99, 3:1:0.97, 3:1:0.95, 3:1:0.93, 3:1:0.9.

LMFP contains a stoichiometric ratio of lithium to manganese to iron to phosphorus of 6:1:1:2, where the amount of manganese and iron can be varied so long as they add to 2 in the given ratio, and neither drops below 0.1 or above 1.9 in the given ratio. There is also room for error, and excess reactants are collected as waste. The true ratio of lithium precursor to manganese precursor to iron precursor to phosphorus precursor may be 6:1:1:2, 6:0.1:1.9:2, 6:0.2:1.8:2, 6:0.3:1.7:2, 6:0.4:1.6:2, 6:0.5:1.5:2, 6:0.6:1.4:2, 6:0.7:1.3:2, 6:0.8:1.2:2, 6:0.9:1.1:2, 6:1.1:0.9:2, 6:1.2:0.8:2, 6:1.3:0.7:2, 6:1.4:0.6:2, 6:1.5:0.5:2, 6:1.6:0.4:2, 6:1.7:0.3:2, 6:1.8:0.2:2, 6:1.9:0.1:2, 6.6:1:1:2, 6.5:1:1:2, 6.3:1:1:2, 6.2:1:1:2, 6.1:1:1:2, 5.9:1:1:2, 5.8:1:1:2, 5.7:1:1:2, 5.5:1:1:2, 5.4:1:1:2, 6:1:1:2.2, 6:1:1:2.15, 6:1:1:2.1, 6:1:1:2.05, 6:1:1:2.02, 6:1:1:1.98, 6:1:1:1.95, 6:1:1:1.9, 6:1:1:1.85, 6:1:1:1.8.

In the process for forming LFP/LMFP, where there are 3 CSTRs in the series of CSTRs, the first reactant solution and the second reactant solution may have a residence time of 1-3 hours, 1-2 hours, 0.75-1.5 hours, 1-1.5 hours, 0.75-1.25 hours, 1-4 hours, 2-4 hours, 2-3 hours, 1-1.25 hours, 0.8-1.2 hours, 1.25-1.75 hours, 1 hour, 1.5 hours, 2 hours, 2.5 hours, 3 hours, or 4 hours through all 3 CSTRs. The individual residence time per CSTR may be 20-60 minutes, 20-40 minutes, 30-60 minutes, 20-80 minutes, 20-90 minutes, 30-90 minutes, 30-45 minutes, 60-80 minutes, 15-30 minutes, 15-45 minutes, 20-40 minutes, 20 minutes, 30 minutes, 40 minutes, 45 minutes, 50 minutes, or 60 minutes.

In the process for forming LFP/LMFP, the carbon source may be sucrose added at 10-20 weight % of a theoretical yield of the LFP/LMFP product, or 10-15 weight %, 15-20 weight %, 12-18 weight %, 11-19 weight %, 13-17 weight %, 14-16 weight %, 14.5-15.5 weight %, or 15 weight %.

In the process for forming LFP/LMFP, the one or more CSTRs in series can be operated at 120-220 °C, 150-220 °C, 175-215 °C, 150-215 °C, 120-200 °C, 130-200 °C, 150-200 °C, 160-200 °C, 175-200 °C, 160-190 °C, 140-190 °C, 150-190 °C, 120-180 °C, 140-180 °C, 150-180 °C, 160-180 °C, 175-185 °C, or 180 °C. The pressure the one or more CSTRs in series are operated at is dependent on the temperature, as the pressure must keep the first reactant solution and the second reactant solution in liquid phase through the one or more CSTRs in series. The minimum determined by a water-saturation pressure vs temperature table. The pressure may be at least 150 psig, at least 160 psig, at least 170 psig, at least 175 psig, at least 180 psig, at least 190 psig, at least 200 psig, at least 210 psig, at least 220 psig, at least 225 psig, at least 230 psig, at least 240 psig, or at least 250 psig.

In the process for forming LFP/LMFP, the continuous rotary kiln may sinter the LFP/LMFP product at 400-750 °C, 500-800 °C, 500-750 °C, 550-800 °C, 550-700 °C, 600-800 °C, 600-700 °C, 600-650 °C, 550-650 °C, 575-625 °C, 600 °C, 650 °C, 550 °C, or 700 °C. It may sinter the LFP/LMFP product for 2-4 hours, 2-3 hours, 2.5-4 hours, 2-3.75 hours, 2.25-2.75 hours, 2-2.5 hours, 2.5-3 hours, 2.5-2.75 hours, 3-4 hours, 2.2-2.8 hours, 2 hours, 2.25 hours, 2.5 hours, 2.75 hours, 3 hours, 3.5 hours, or 4 hours.

In the process for forming LMFP, a surfactant is added (preferably CTAB) which has a molarity of 0.1 M CTAB in the one or more CSTRs in series containing both the first reactant solution and the second reactant solution. The true molarity may be 0.09-0.11 M, 1-1.15 M, 1-1.11 M, 0.09-1.15 M, 1-1.1 M, or 1-1.05 M.

In the process for forming LMFP the second solvent comprises a ratio of ethylene glycol to water, which may be 1:1, 1.1:1, 1.05:1, 1.025:1, 0.9:1, 0.95:1, 1:1.1, 1:1.05, 1:1.025, 1:0.9, 1:0.95.

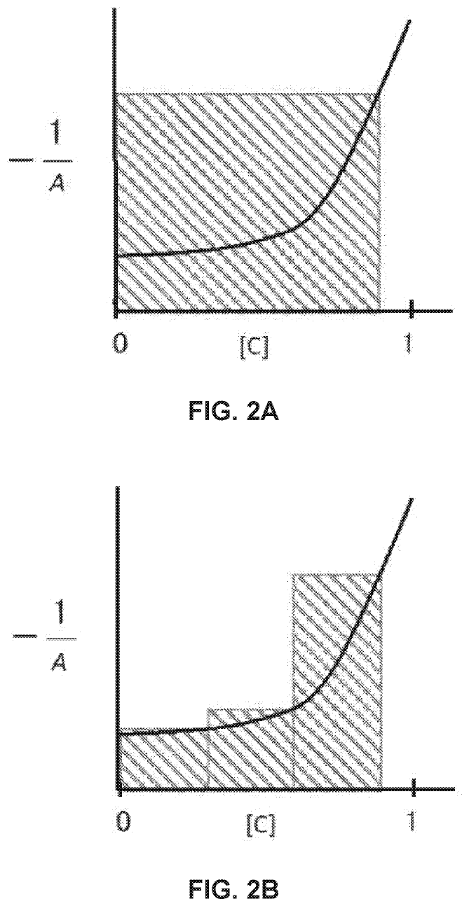

The present disclosure teaches performing the hydrothermal synthesis reaction as a continuous process instead of a batch process. To produce the LFP/LMFP, Continuous Stirred Tank Reactors (CSTR) are used. The CSTRs are large pressure vessels that can accommodate varying gas headspaces, are commonly used in liquid-solid phase reactions, and allow for the solids that are generated in the LFP process to easily pass through the system. The design equation for a CSTR is shown in Equation 1.

$$V = \frac{{F}_{A 0} X}{{( - {r}_{A} )}_{e x i t}} \qquad ( 1 )$$

Where V is the reactor volume, F_{A0} is the molar flowrate into the system, X is the conversion, and (r_{A})ₑₓᵢₜ is the reaction rate at the exit conditions. The exit composition of a CSTR is considered identical to the composition inside (assuming perfect mixing), so the reaction rate is evaluated at the exit conditions. Based on this design equation, the volume of a CSTR required to produce LFP/LMFP at a given flow rate and conversion can be determined. However, the total volume required, and the efficiency of the process can be improved by using multiple CSTRs in series. This allows the effluent from one reactor to become the feed for the next so that the new starting concentration changes. For positive order kinetics, the reaction rate increases with increasing reactant concentration. Therefore, having multiple CSTRs that gradually decrease in reactant concentration (as LFP/LMFP is produced) can improve the overall reaction rate of the process (compared to a single CSTR run at the same conversion) and allow for an overall lower reactor volume. As the number of CSTRs in series increases, the system begins to approximate a plug flow reactor (PFR). This is illustrated in FIGS. 2A-2B. For arbitrary positive order reaction kinetics (shown in the black line), the volume required for a single reactor is shown in the shaded rectangle in FIG. 2A. However, for three reactors in series (FIG. 2B) the total area is significantly lower (illustrated by the smaller total shaded region, with much less area above the curve). The optimal number of reactors to minimize the total reactor volume required depends on the reaction kinetics, but three reactors give an excellent approximation of a PFR (the most efficient reactor type).

CSTRs in series are an ideal choice for this reaction as it is an efficient method of reaching high conversion in a process that generates a solid product. Unlike tubular reactors, CSTRs can handle solids production without plugging. CSTRs have been used as reactors for producing fertilizers (crystalline ammonium phosphate) in very high volume for decades, so large scale equipment is already commercially used and available. Fertilizer production is one of the highest volume chemical syntheses in the world, so any scale needed for the battery market can be easily accommodated with this well-established reactor technology and process design. A CSTR is the simplest crystallizer used industrially, so processes that are amenable to this system design are ideal to reduce the capital and maintenance costs of the process. Therefore, the present LFP/LMFP process has been designed using the state-of-the-art chemical processing equipment and can be readily scaled up to any quantity needed.

Using the disclosed continuous method for making LFP/LMFP can reduce operating expenses by at least 90% and capital expenses by at least 50%. This is because the process continually feeds reactants into the reactor and removes the product without any changes in temperature or pressure. The process can run 24/7 with no down time for loading and unloading or heat up and cool down, and the reactor sizes are much smaller than what is needed to make the same amount of product in a batch process.

It is important that the reactors are capable of effective stirring, meaning that they do not stop turning if too much powder collects at the bottom, and they produce vertical circulation in the reactor. Small magnetic stir bars and even rapidly spinning stir-bars are not effective. Larger vessels with paddle type impellers and overhead stirrer motors are an example that achieves consistent agitation. Having CSTRs in a series promotes a faster reaction time, as new reactants can be constantly flowing into the first CSTR to begin reacting. As reacting solution feeds through the system, the concentration of reacted LFP/LMFP product increases in each successive CSTR, and product can be collected from the reactors earlier than if one had to wait for all reactants to mix and react in a single batch.

### Continuous Hydrothermal Process for Making LFP:

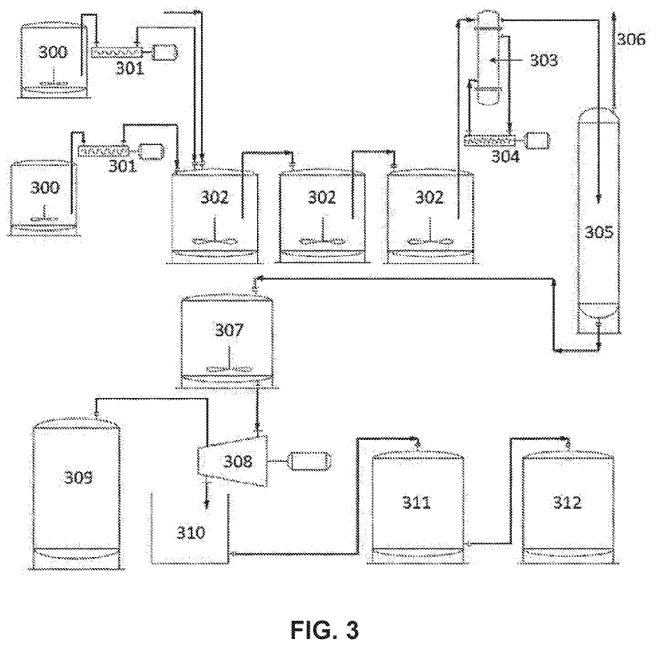

The Process Flow Diagram (PFD) for the present continuous hydrothermal process for making LFP is shown in FIG. 3. To demonstrate the LFP continuous production process, three CSTRs plumbed in series are used. Any number of one or more CSTRs can be used in other embodiments. Each reactor has a motor-driven stirrer, rupture disc, pressure transducer, furnace heater, and input/output ports. The CSTRs are purged with nitrogen and the whole system is kept under a pressure of 200 psig using a pressure control valve. The reactants are fed to the first reactor using two high pressure pumps connected to feed tanks. One tank contains the lithium precursor and carbon source, and the other tank contains the iron and phosphorus precursors. The solution continues to mix and flow into the second and third reactors. The product is then cooled and collected in a collection tank which is equipped with level sensors. When the level in the collection tank reaches the high sensor, a bottom valve opens to depressurize and deliver the LFP product slurry to a slurry tank. The LFP slurry is then fed to a continuous centrifugal separator to remove the water from the LFP solid particles. The solids exit the centrifuge as a wet cake and are deposited in a collection vessel. The collected LFP is then spread across drying trays, and sintered under nitrogen using a continuous rotary furnace.

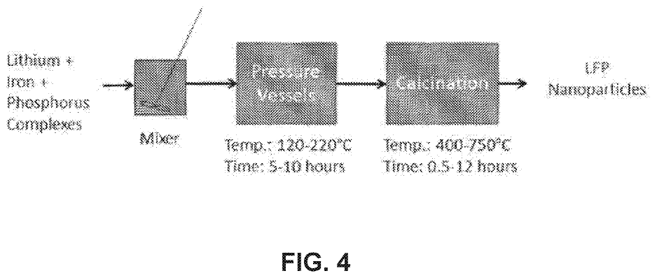

The general disclosed procedure for preparing LFP is to prepare a mixture of compounds with the essential elements of lithium, iron, and phosphorus (such as lithium hydroxide, iron sulfate, and phosphoric acid) at the correct ratio in water, though organic solvents could also be used; all these chemicals are locally available, abundant, and inexpensive. Possible lithium precursors include lithium hydroxide (LiOH), lithium carbonate (Li₂CO₃), and lithium nitrate (LiNO₃). Possible iron precursors include iron phosphate (FeSO₄), iron nitrate (Fe(NO₃)₂), and iron chloride (FeCl₂). Possible phosphorus precursors include phosphoric acid (H₃PO₄), ammonium dihydrogen phosphate ((NH₄)H₃PO₄), and diammonium hydrogen phosphate ((NH₄)₂HPO₄). A carbon source (such as sucrose) is added to the feed tank containing lithium to later form a carbon coating, increasing the electrical conductivity of the LFP. It also prevents oxidation of iron during calcination. The aqueous solution is then heated under pressure at a reaction temperature of 120-220 °C in the one or more CSTRs, producing LFP active material. The concentration, time, and temperature of the process all influence the particle size and purity of the product. The LFP product is collected and sintered at 400-750 °C for 0.5-12 hours under nitrogen to produce pure crystalline LFP in a continuous rotary kiln. FIG. 4 shows the schematic to produce LFP.

The LFP continuous production process is demonstrated using three 1 gal (3.8 L) Parr reactors (CSTRs) (rated to 1900 psi and 350 °C) in series. Each reactor has a motor-driven stirrer, rupture disc, pressure transducer, furnace heater, and input/output ports. To start the process, the reactors are purged with nitrogen, the whole system is kept under a pressure of 200 psig N₂ using a pressure control valve, and consistent flow is verified. The preferred flow rate is determined using equation 1. The reactants are kept in two feed tanks, with one tank containing the lithium precursor and carbon source and the other containing the iron and phosphorus precursors. The reactants are fed to the first reactor using two high pressure pumps. The solution continues to flow into the second and third reactors, which are all operated under the same pressure and temperature, specified so the reactants are above boiling temperature and remain in a liquid state. The product is then cooled and collected in a tank which is equipped with level sensors. When the level sensor is activated, a bottom valve opens to depressurize and deliver the LFP product slurry to a slurry tank. The LFP slurry is then fed to a continuous centrifugal separator to remove the water, unreacted starting materials, and unwanted by-products from the LFP solid particles. The collected LFP is then sintered under nitrogen using a continuous rotary furnace. Based on the PFD shown in FIG. 3, larger-scale systems with specific equipment can be designed, assembled, and tested to produce a process plant capable of producing thousands of tons of LFP per year. FIG. 3 shows two separate feed tanks (300) connected to three CSTRs in series (302) by high pressure pumps (301), heat exchanger (303) with cooling water (304), product collection tank (305) showing direction to vent (306), slurry tank (307), centrifugal separator (308), waste water (309) and LFP product collection (310), LFP dryer (311), and calciner (312).

Prior to mixing, the reactants are kept separately in two large feed tanks. The headspaces of both tanks are kept under an inert gas blanket to prevent dissolved oxygen from reacting with the solutions. One tank contains the lithium precursor and carbon source, and the other contains the iron and phosphorus precursors. The process does not work unless the iron and phosphorus precursors are pre-mixed (i.e. using 3 separate solutions would not work). All the reactants are kept in aqueous states, maybe using water as a solvent. The final desired product is a powder, so the water or other solvent must be later removed by a centrifugal separator or equivalent solid-liquid separation technology. The tanks are operably connected to high pressure pumps, which can be switched on to activate the entire system. Once turned on, the reactants flow each at a constant flow rate into the first CSTR where they begin mixing. The reactants must be fed at an appropriate 3:1:1 molar ratio (lithium to iron to phosphorus) to ensure a proper reaction with even heating of the reactants. When reactants are mixed in a line before entering the reactor, they can form a gel and plug up the line, so it is critical they not mix until entering the CSTR. Each CSTR is operably connected to the next CSTR, so the reaction will flow at a same constant rate between the CSTRs, with each successive CSTR having a higher concentration of formed active LFP product. The final CSTR has an outlet which is operably connected to the collection tank, where the aqueous active LFP product is dispensed.

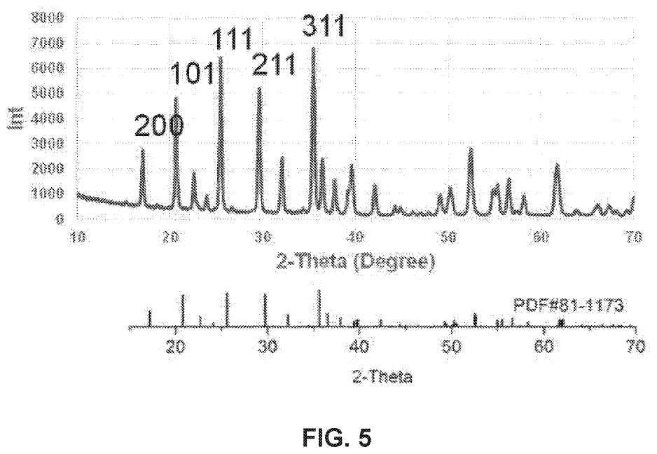

Lithium precursors and solvents can be varied, and optimal starting conditions are presented. Water and organic solvents can be used, though it is crucial that all precursors are fully soluble in the chosen solvent—100% ethylene glycol serves as an example that does not meet this criterion. The formation of LFP does not occur at an acceptable rate when the pH is too acidic, so the mixture of precursors must be relatively neutral. For example, a mixture of lithium nitrate, iron sulfate, and phosphoric acid is highly acidic—the use of sodium hydroxide is required to neutralize the solution, favoring the production of 52% alluaudite (Fe₃Na_{1.7}O₁₂P₃) over LFP. In preferable contrast, using lithium hydroxide rather than lithium nitrate neutralizes the phosphoric acid, and avoids unwanted byproduct formation. The initial pH of this combination is 8.5, which is perfect for making LFP. FIG. 5 shows >96% LFP formed at ≥99% purity using lithium hydroxide, iron sulfate, and phosphoric acid. The main phase of all materials can be assigned to an ordered olivine structure indexed by orthorhombic Pₙₘₐ olivine structure (JCPDS No. 40-1499). The overall reaction in the solution is:

3LiOH+FeSO₄+H₃PO₄→LiFePO₄+Li₂SO₄+3H₂O

Adding a carbon source to the to the compound is crucial to protect the LFP crystals from further crystallization and secondary phase formation (forming tavorite). After heating and calcinating, the sugar is converted to carbon, forming a conductive layer that also protects the LFP from oxidation. The coating increases the product's electronic conductivity, which improves its performance in LFP batteries. Sugars may serve as the carbon source. Typically, the carbon source is added post-LFP synthesis (just before sintering). Adding the sugar after the hydrothermal reaction is run requires additional steps, such as ball-milling, mixing, and drying, and can cause the charge transfer resistance of the LFP cathode to be too high even after sintering the active materials. By adding the carbon source to the reactants, additional steps are eliminated from the procedure, and the resulting carbon coating is more uniform with better capacitance than if added pre-sintering.

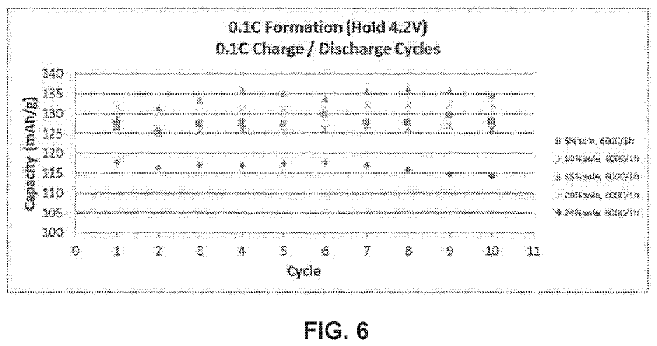

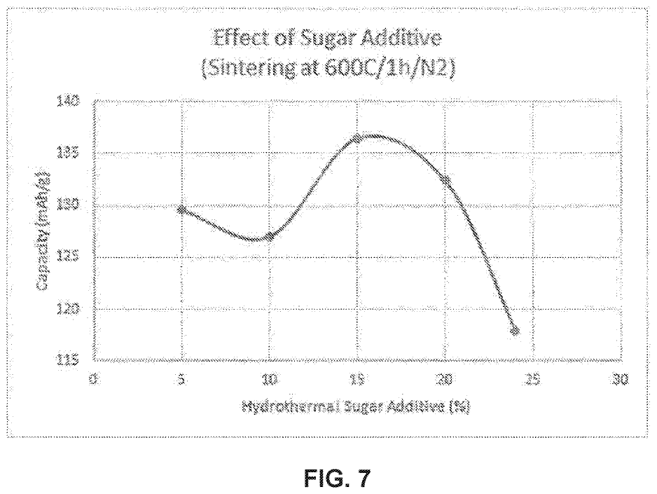

The preferred method adds a higher sugar concentration directly to the hydrothermal reaction aqueous mixture. Compared to the theoretical yield of LFP, the added sugar concentration should be 5-20 weight %, more preferably 10-20 weight %, and most preferably 15 weight % (>135 mAh/g). FIG. 6 shows coin cell performance at different sugar loadings, with 15% producing cathode materials with the highest capacitance. FIG. 7 shows discharge capacity at different sugar loading concentrations, peaking at 15% hydrothermal sugar additive.

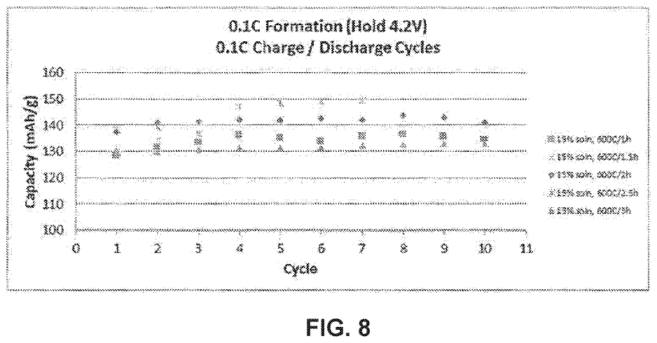

Sintering at 600 °C under nitrogen is sufficient to carbonize the sugar. Sintering time should be as short as possible to save energy, and also because longer sintering times increase the crystal particle size, which reduces LFP performance. However, there must be a balance where the sintering time is long enough to convert all the sugars into carbon. The sintering time should be 1-3 hours, more preferably 2.5-3 hours, and most preferably 2.5 hours. FIG. 8 shows coin cell performance at different sintering times, with the LFP cathode which was sintered for 2.5 hours showing the highest capacity. During the second discharge cycle, the voltage increased from 3.5 V to 4.2 V, but its capacity is the same as the first charge, indicating good electrode stability. The second discharge has an even higher capacity, showing an improvement of discharge capacity after its formation. These charge/discharge capacities show excellent LFP formation and performance, even at 90% state of charge (SOC).

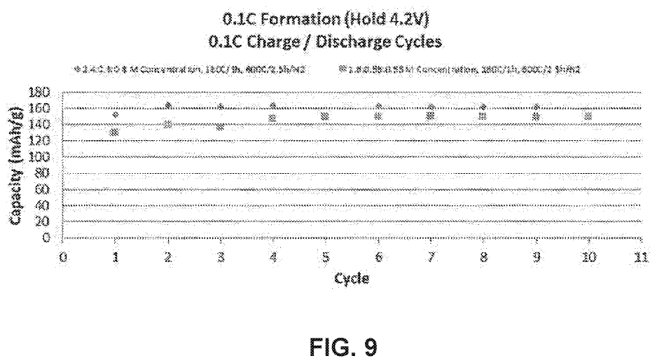

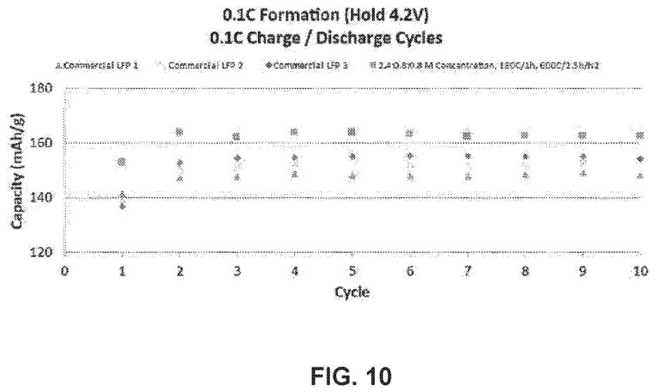

The optimal hydrothermal batch reaction is 120-200 °C, most preferably 180 °C. The overall reaction time takes less than 4 hours, and the hydrothermal reaction itself takes at most 1 hour to complete. By increasing the reaction concentration, the speed of the reaction increases, and the coin cell's discharge capacity for the resulting LFP cathode also increases as shown in FIG. 9. After 1 hour reaction, the product shows 165 mAh/g discharge capacity even at 90% SOC. This is very close to the theoretical maximum capacity for LFP cathode, which is 170 mAh/g. FIG. 10 shows a comparison of LFP cathodes made in the continuous hydrothermal method, and commercial LFP electrodes. The LFP cathodes with material from the continuous hydrothermal method outperformed all commercial LFP electrodes throughout 10 cycles.

Once the active LFP product has been separated from aqueous reactor waste in the centrifugal separator, it is sintered in a continuous rotary kiln, demonstrated with a Bartlett and Snow rotary kiln. The kiln is heated preferably to 600 °C to convert all the sucrose into carbon. To prevent metal contamination of the LFP from the metal tube, a quartz insert can be added. Once the materials exit the kiln, they are cooled and collected. The materials require no further manipulation prior to use in electrodes. Using a large-scale rotary kiln allows for rapid production scale-up.

Using the disclosed continuous method for making LFP can reduce operating expenses by at least 90% and capital expenses by at least 50%. This is because the process continually feeds reactants into the reactor and removes the product without any changes in temperature or pressure. The process can run 24/7 with no down time for loading and unloading or heat up and cool down, and the reactor sizes are much smaller than what is needed to make the same amount of product in a batch process.

The continuous hydrothermal process for making LFP produces small, uniform particle sizes, averagely 30-40 nm. Particle size and distribution are controllable parameters which have high impact on lithium battery performance, including charge/discharge characteristics, capacity, coloumbic and energy efficiencies, cycling stability, and C-rate capability. The presence of large particles promotes lithium plating, which lowers cell performance and threatens the safety of battery operation. To avoid the presence of coarse LFP particles, many current production procedures rely on grinding, pounding, and sieving, which also often require additional cooling and/or drying breaks. By using the continuous hydrothermal process, time is saved, the yield of usable product is increased, and costs associated with removing larger particles are eliminated.

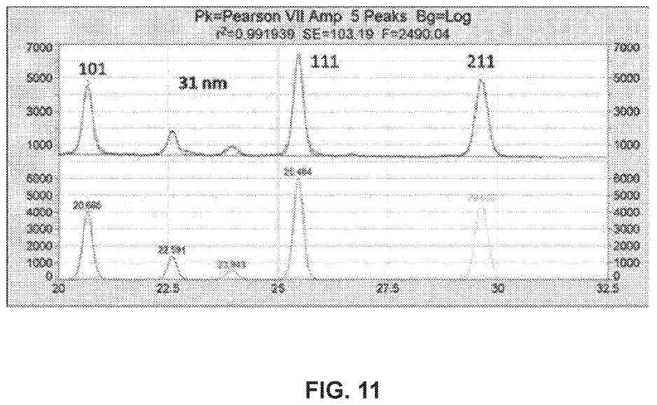

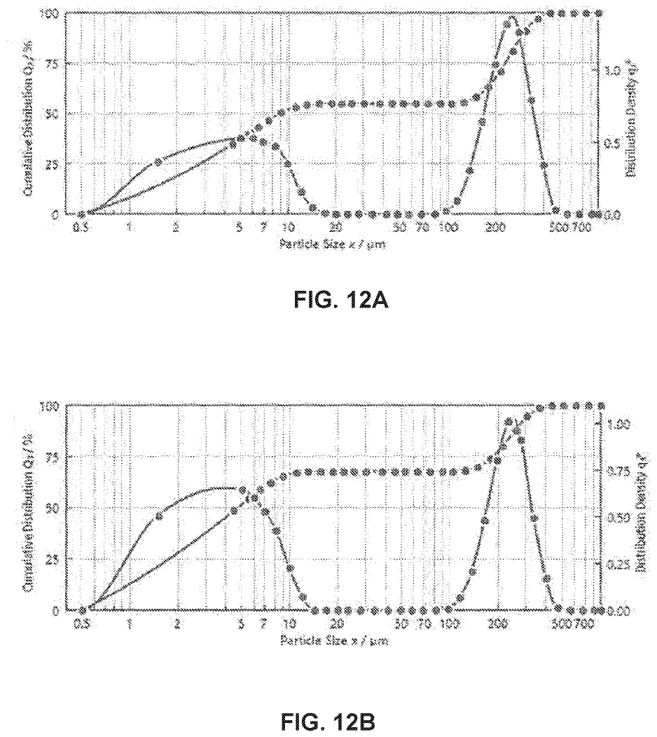

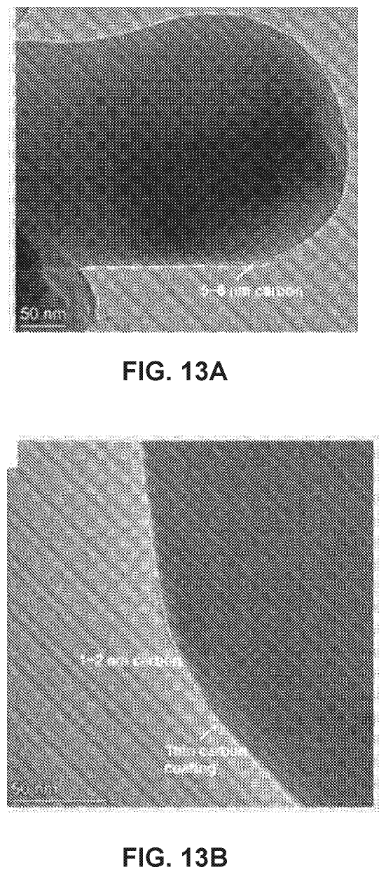

The size of the crystal particle is estimated after fitting and calculating the XRD peaks using the Scherrer equation shown in FIG. 11. The fitting data indicates that the LFP product contains 31 nm particles, smaller than the commercial LFP (~55 nm). Since smaller particles have higher active surface areas, LFP produced using the present method can increase the charge/discharge capacity during battery cycling. Under dry conditions, particle size analysis shows the particles are less agglomerate and have smaller particle sizes (FIGS. 12A-B). The present LFP contains a clean carbon layer around the particles. The uniform and thin carbon layers are 1-6 nm, sufficient to provide electron conductivity without limiting lithium diffusion. FIGS. 13A-B shows TEM of the thin carbon coating on LFP produced by the continuous hydrothermal process, measuring 1-2 nm in thinner locations and 5-6 nm in thicker locations.

LFP produced by the continuous hydrothermal process has an average density of 3.96 g/cm³ and an average volume of 0.15 cm³. Table 1 shows results of 10 scans of the LFP's specific gravity using a gas pycnometer. The LFP also has a tap density of 0.971 g/cm³.

TABLE 1
Gas Pycnometer Run Data

| Run | Volume (cm³) | Density (g/cm³) | Temperature (°C) |
|---|---|---|---|
| 1 | 0.1555 | 3.8785 | 19.996 |
| 2 | 0.1511 | 3.9929 | 19.997 |
| 3 | 0.1530 | 3.9435 | 20.006 |
| 4 | 0.1525 | 3.9565 | 19.995 |
| 5 | 0.1494 | 4.0375 | 19.998 |
| 6 | 0.1520 | 3.9681 | 20.003 |
| 7 | 0.1516 | 3.9790 | 19.999 |
| 8 | 0.1530 | 3.9427 | 19.999 |
| 9 | 0.1523 | 3.9616 | 20.002 |
| 10 | 0.1526 | 3.9545 | 19.997 |

### Continuous Hydrothermal Process for Making LMFP:

Lithium manganese iron phosphate (LMFP) can be made using an analogous process. The starting materials in the large feed tanks are modified, but the rest of the process and optimized conditions are consistent with the continuous hydrothermal process for making LFP. The first feed tank is unchanged, containing lithium precursor and a carbon source mixed preferably in water. The second feed tank contains manganese precursor, iron precursor, and phosphorus precursor mixed preferably in a water and ethylene glycol mixture. Cetyltrimethylammonium bromide (CTAB) is preferably added to the second feed tank as a surfactant to increase the reaction kinetics.

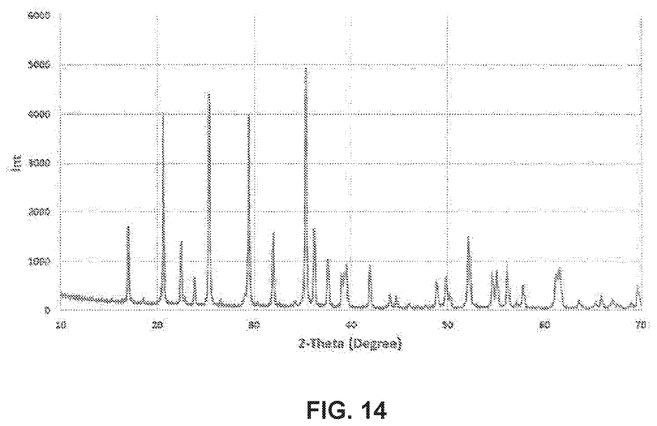

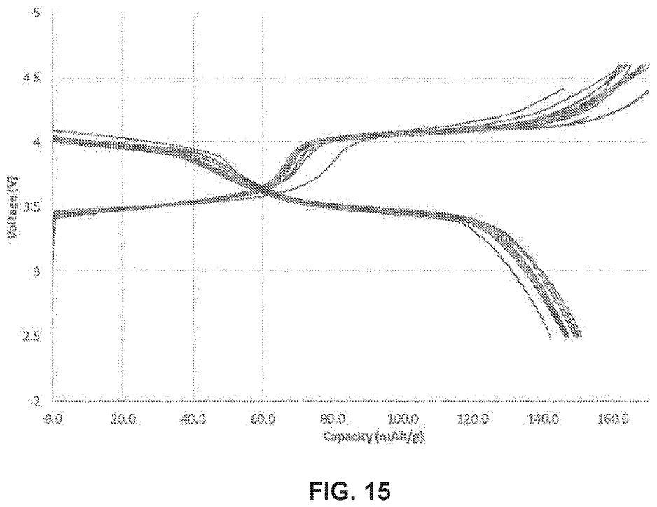

The reactants for LMFP production flow through the reactors in the same way and under the same conditions as for LFP production. The flow rate remains constant through the one or more CSTRs in series, and the entire system is kept at 180 °C, 200 psig, and under a nitrogen air atmosphere. The product then flows through a collection tank, an agitated slurry tank, a centrifugal separator, and finally into a collection vessel where it is transferred to a continuous rotary kiln for drying and to allow a thin carbon coating to form around LMFP particles. An XRD of the LMFP particles produced by the continuous hydrothermal process is shown in FIG. 14. The resulting LMFP electrode material has a stable capacitance as shown in FIG. 15.

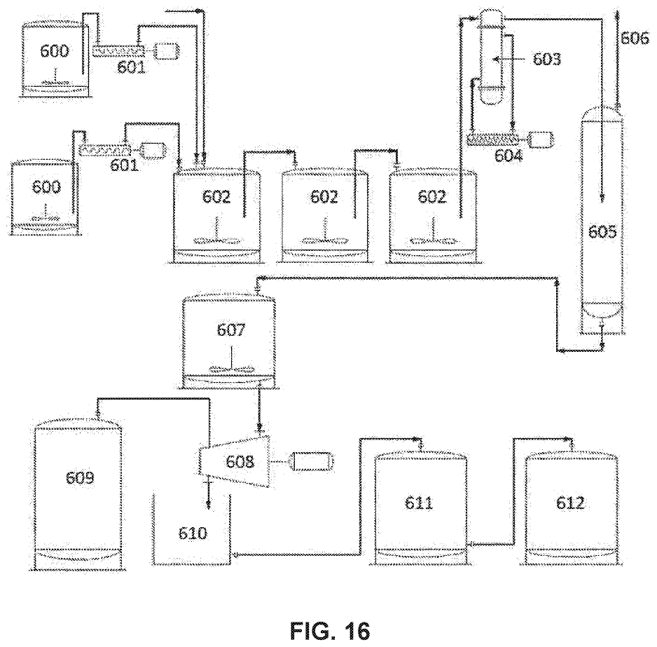

The setup for the continuous hydrothermal process for making LMFP is practically identical to that of making LFP, with only the starting materials being different. All system specifications made in the description for making LFP apply to the system for making LMFP. The Process Flow Diagram (PFD) for the continuous hydrothermal process for making LMFP is shown in FIG. 16. To demonstrate the LMFP continuous production process, three CSTRs plumbed in series are used. Each reactor has a motor-driven stirrer, rupture disc, pressure transducer, furnace heater, and input/output ports. The CSTRs are purged with nitrogen and the whole system is kept under a pressure of 200 psig using a pressure control valve. The reactants are fed to the first reactor using high pressure pumps with operably connected to two feed tanks. One tank contains the lithium precursor and carbon source and the other tank contains the manganese, iron, and phosphorus precursors, and preferably a surfactant such as CTAB. The solution continues to flow into the second and third reactors. The product is then cooled and collected in a collection tank which is equipped with level sensors. When the product in the collection tank activates the level sensors, a bottom valve opens to depressurize and deliver the LMFP product slurry to a slurry tank. The LMFP slurry is then fed to a continuous centrifugal separator to remove the water, ethylene glycol, unreacted reactants, and unwanted by-products from the LMFP solid particles. The solids exit the centrifuge as a wet cake and are deposited in a collection vessel. The collected LMFP is then spread across drying trays, and sintered under nitrogen using a continuous rotary furnace.

The general disclosed procedure for preparing LMFP is to prepare a mixture of compounds with the essential elements of lithium, manganese, iron, and phosphorus (such as lithium hydroxide, manganese sulfate, iron sulfate, and phosphoric acid) at the correct ratio in water or water and ethylene glycol, though organic solvents could also be used; all these chemicals are locally available, abundant, and inexpensive. Possible lithium precursors include lithium hydroxide (LiOH), lithium carbonate (Li₂CO₃), and lithium nitrate (LiNO₃). Possible iron precursors include iron phosphate (FeSO₄), iron nitrate (Fe(NO₃)₂), and iron chloride (FeCl₂). Possible phosphorus precursors include phosphoric acid (H₃PO₄), ammonium dihydrogen phosphate ((NH₄)H₃PO₄), and diammonium hydrogen phosphate ((NH₄)₂HPO₄). Possible manganese precursors include manganese sulfate (MnSO₄), manganese carbonate (MnCO₃), manganese nitrate (Mn(NO₃)₂), and manganese chloride (MnCl₂). A carbon source (such as sucrose) is added to the feed tank containing lithium to later form a carbon coating, increasing the electrical conductivity of the LMFP. It also prevents oxidation of iron during calcination. The aqueous solution is then heated under pressure at a reaction temperature of 120-220 °C in water, producing LMFP active material. The concentration, time, and temperature of the process all influence the particle size and purity of the product. The LMFP product is collected and sintered at 400-750 °C for 0.5-12 hours under nitrogen to produce pure crystalline LMFP.

The LMFP continuous production process is demonstrated using three 1 gal (3.8 L) Parr reactors (CSTRs) (rated to 1900 psi and 350 °C) in series. Each reactor has a motor-driven stirrer, rupture disc, pressure transducer, furnace heater, and input/output ports. To start the process, the reactors are purged with nitrogen, the whole system is kept under a pressure of 200 psig N₂ using a pressure control valve, and consistent flow is verified. The preferred flow rate is determined using equation 1. The reactants are kept in two feed tanks, with one tank containing the lithium precursor and carbon source and the other containing the manganese, iron, and phosphorus precursors as well as preferably CTAB. The reactants are fed to the first reactor using two high pressure pumps. The solution continues to flow into the second and third reactors, which are all operated under the same pressure and temperature, specified so the reactants are above boiling temperature and remain in a liquid state. The product is then cooled and collected in a tank which is equipped with level sensors. When the level sensor is activated, a bottom valve opens to depressurize and deliver the LMFP product slurry to a slurry tank. The LMFP slurry is then fed to a continuous centrifugal separator to remove the water, unreacted starting materials, and unwanted by-products from the LMFP solid particles. The collected LMFP is then sintered under nitrogen using a continuous rotary furnace. Based on the PFD shown in FIG. 16, larger-scale systems with specific equipment can be designed, assembled, and tested to produce a process plant capable of producing thousands of tons of LFP per year. FIG. 16 shows two separate feed tanks (600) connected to three CSTRs in series (602) by high pressure pumps (601), heat exchanger (603) with cooling water (604), product collection tank (605) showing direction to vent (606), slurry tank (607), centrifugal separator (608), waste water (609) and LMFP product collection (610), LFP dryer (611), and calciner (612).

Prior to mixing, the reactants are kept separately in two large feed tanks. The headspaces of both tanks are kept under an inert gas blanket to prevent dissolved oxygen from reacting with the solutions. One tank contains the lithium precursor and carbon source, and the other contains the manganese, iron, and phosphorus precursors and preferably CTAB. The process does not work unless the manganese, iron, and phosphorus precursors are pre-mixed (i.e. using 4 separate solutions would not work). All the reactants are kept in aqueous states, using water as a solvent for the lithium precursor and a 1:1 volumetric ratio of water and ethylene glycol for the manganese, iron, and phosphorus precursors. The final desired product is a powder, so the solvent must be later removed by a centrifugal separator or equivalent solid-liquid separation technology. The tanks are operably connected to high pressure pumps, which can be switched on to activate the entire system. Once turned on, the reactant solutions each flow at a constant flow rate into the first CSTR where they begin mixing. The reactants must be fed at an appropriate 6:1:1:2 molar ratio (lithium to manganese to iron to phosphorus) to ensure a proper reaction with even heating of the reactants. When reactants are mixed in a line before entering the reactor, they can form a gel and plug up the line, so it is critical they not mix until entering the CSTR. Each CSTR is operably connected to the next CSTR, so the reaction will flow at the same constant rate between the CSTRs, with each successive CSTR having a higher concentration of formed active LMFP product. The final CSTR has an outlet which is operably connected to the collection tank, where the aqueous active LMFP product is dispensed.

Lithium precursors and solvents can be varied, though optimal starting conditions are presented. Water and organic solvents can be used, though it is crucial that all precursors are fully soluble in the chosen solvent. Water is the preferred solvent for the lithium precursor, while a 1:1 volumetric ratio of water and ethylene glycol is the preferred solvent for the manganese, iron, and phosphate precursors. The formation of LMFP does not occur at an acceptable rate when the pH is too acidic, so the mixture of precursors must be relatively neutral. Using lithium hydroxide, for example, neutralizes the phosphoric acid and avoids unwanted byproduct formation. The overall reaction in the solution is:

3LiOH+0.5MnSO₄+0.5FeSO₄+H₃PO₄→LiMn_{0.5}Fe_{0.5}PO₄+Li₂SO₄+3H₂O

Adding a carbon source to the to the compound is crucial to protect the LMFP crystals from further crystallization and secondary phase formation (forming tavorite). After heating and calcinating, the sugar is converted to carbon, forming a conductive layer that also protects the LMFP from oxidation. The coating increases the product's electronic conductivity, which improves its performance in LMFP batteries. Sugars may serve as the carbon source. Typically, the carbon source is added post-LMFP synthesis (just before sintering). Adding the sugar after the hydrothermal reaction is run requires additional steps, such as ball-milling, mixing, and drying, and can cause the charge transfer resistance of the LMFP cathode to be too high even after sintering the active materials. By adding the carbon source to the reactants, additional steps are eliminated from the procedure, and the resulting carbon coating is more uniform with better capacitance than if added pre-sintering.

The preferred method adds a higher sugar concentration directly to the hydrothermal reaction aqueous mixture. Compared to the theoretical yield of LFP, the added sugar concentration should be 5-20 weight %, more preferably 10-20 weight %, and most preferably 15 weight % (>135 mAh/g).

Sintering at 600 °C under nitrogen is sufficient to carbonize the sugar. Sintering time should be as short as possible to save energy, and also because longer sintering times increase the crystal particle size, which reduces LMFP performance. However, there must be a balance where the sintering time is long enough to convert all the sugars into carbon. The sintering time should be 1-3 hours, more preferably 2.5-3 hours, and most preferably 2.5 hours.

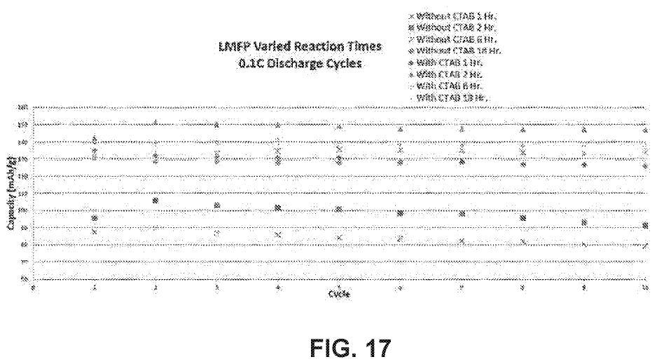

The optimal hydrothermal batch reaction is 120-200 °C, most preferably 180 °C. The overall reaction time takes less than 4 hours, and the highest capacity LMFP electrode is formed after 2 hours of reacting, with CTAB present (FIG. 17). By increasing the reaction concentration, the speed of the reaction increases. CTAB improves reaction kinetics, with 0.1 mol CTAB added per liter of total reactant solution. CTAB can be added to the second feed tank containing manganese, iron, and phosphorus in water and ethylene glycol. The amount of CTAB added is dependent on the total reaction volume and flow rates, and there should be about 0.1 M CTAB present in the one or more CSTRs in series as the reaction flows.

Once the active LMFP product has been separated from aqueous reactor waste in the centrifugal separator, it is sintered in a continuous rotary kiln, demonstrated with a Bartlett and Snow rotary kiln. The kiln is heated preferably to 600° to convert all the sucrose into carbon. To prevent metal contamination of the LMFP from the metal tube, one may add a quartz insert. Once the materials exit the kiln, they are cooled and collected. Using a large scale rotary kiln allows for rapid production scale-up.

The continuous hydrothermal process for making LMFP produces small, uniform particle sizes, averagely 30-40 nm. Particle size and distribution are controllable parameters which have high impact on lithium battery performance, including charge/discharge characteristics, capacity, coloumbic and energy efficiencies, cycling stability, and C-rate capability. The presence of large particles promotes lithium plating, which lowers cell performance and threatens the safety of battery operation. To avoid the presence of coarse LMFP particles, many current production procedures rely on grinding, pounding, and sieving, which also often require additional cooling and/or drying breaks. By using the continuous hydrothermal process, time is saved, the yield of usable product is increased, and costs associated with removing larger particles are eliminated.

Since smaller particles have higher active surface areas, LMFP produced using the present procedure can increase the charge/discharge capacity during battery cycling. Under dry conditions, particle size analysis shows the particles are less agglomerate and have smaller particle sizes. The present LMFP contains a clean carbon layer around the particles. The uniform and thin carbon layers are 1-6 nm, sufficient to provide electron conductivity without limiting lithium diffusion.

Example 1: LFP production via 1 reactor. Two feed solutions are prepared and loaded into feed vessels connected operably via high pressure pumps to a single CSTR—one with LiOH (2.4 M) and 15 wt % sucrose dissolved in DI water, the other with a FeSO₄ (0.8 M) and H₃PO₄ (0.8 M) also dissolved in DI water. The CSTR is purged and kept under N₂ pressure (~200 psig). The solutions are pumped into the CSTR so a 3:1:1 molar ratio of lithium to iron to phosphorus is maintained. After 1 hour residence time in the CSTR at 180 °C, the reacted solution flows into a collection tank to cool and depressurize. The mixture then flows to a slurry tank where it is agitated before entering a centrifugal separator. Water and by-products are separated from solid LFP from the reaction. Solid LFP is transferred to a continuous rotary kiln and sintered at 600 °C for 2.5 hours under nitrogen. Characterization of LFP shown in FIG. 5. Particle size analysis shown in FIG. 11.

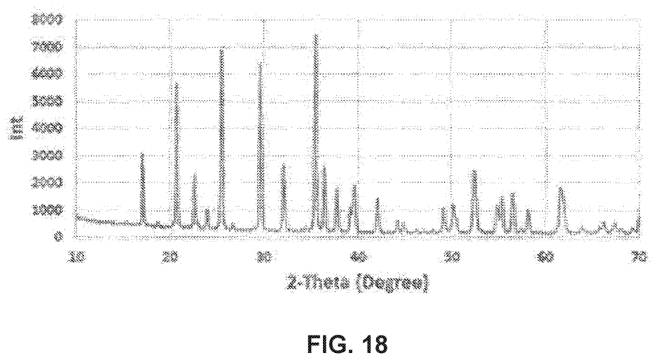

Example 2: LFP production via 3 reactors. Two feed solutions are prepared and loaded into feed vessels connected operably via high pressure pumps to the series of CSTRs. The first feed solution is LiOH and 15 wt % sucrose in DI water. The second solution is FeSO₄ and H₃PO₄ in DI water. The head space of both feed tanks are kept under an inert gas blanket. The solutions are pumped at a 3:1:1 stoichiometric ratio of lithium to iron to phosphorus into the first CSTR, which is heated to 180 °C and kept under 200 psig N₂ pressure. The reaction mixture moves from the first CSTR to the second CSTR to the third CSTR, allowing for a 20-30 minute residence time in each reactor vessel (about 1 hour total residence time). The reaction then passes through a collection tank, a heat exchanger, where the product is cooled below 100 °C. The collection tank releases the mixture to flow to a gas/slurry separator and collect the slurry. The slurry is transferred intermittently to an agitated slurry tank, which then feeds a centrifuge which continuously separates the solid product particles from the by-product containing wastewater. The solids exit the centrifuge as a wet cake and are deposited in a collection vessel. These solids are then spread across drying trays to be dried in an oven to remove water. Once the solids are dry, they are calcined in an oven at 600 °C for 2.5 hours. Characterization of LFP shown in FIG. 18.

Example 3: LMFP production via 1 reactor. Two feed solutions are prepared and loaded into vessels operably connected to a single CSTR via pressure pumps. The first contains LiOH dissolved in DI water with 15 wt % sucrose. The second contains FeSO₄*7H₂O, MnSO₄, and H₃PO₄ dissolved in a 1:1 volumetric ratio of DI water and ethylene glycol, as well as CTAB. The amount of CTAB added correlates with 0.1 M CTAB in the CSTR when both reactant solutions are combined. The CSTR is purged at least 3 times and kept under 200 psig N₂ after the final purge. The reactor is heated to 180 °C. The reactants are flowed at a 6:1:1:2 molar ratio of lithium to manganese to iron to phosphorus into the reactor. Residence time in the CSTR is 2 hours. The reaction then flows into a collection tank where it is cooled and depressurized. Once the collection tank is full, it releases into a slurry tank for agitation. The slurry flows to a centrifugal separator which removes the DI water, ethylene glycol, and by-products from LMFP. LMFP is dispensed from the centrifugal separator as a wet cake. The LMFP is sintered at 600 °C for 2-4 hours. Characterization of LMFP shown in FIG. 14.

Example 4: LMFP production via 1 reactor—small batch. LiOH*H₂O (8.06 g) is dissolved in 46 mL DI water in a first beaker. Sucrose (1.626 g) is then added. In a second beaker, FeSO₄*7H₂O (8.9 g) and MnSO₄ (5.4 g) are added in 34 mL DI water and ethylene glycol mixture (1:1 v/v). Then, 85% H₃PO₄ (7.38 g) is added. The CSTR is purged with nitrogen at least 3 times, with nitrogen pressure left in the reactor after the final purge. The reactor is set to 180 °C. The two solutions are slowly added to the CSTR. CTAB (3 g) is added to the CSTR. After approximately 2 hours the reaction flows to a collection tank to cool and depressurize. Then, the product flows to a slurry tank where it is agitated. The slurry then flows to a centrifugal separator, where any water, ethylene glycol, and by-products are separated from the LMFP powder. LMFP powder dispenses from the bottom of the centrifugal separator as a wet cake. This is transferred to a continuous rotary kiln and sinters at 600 °C for 4 hours.

Example 5: LMFP production via 3 reactors. Two feed solutions are prepared and stored in feed vessels operably connected via high pressure pumps to the first of three CSTRs. The first feed solution contains LiOH and 15 wt % sucrose dissolved in DI water. The second feed solution contains MnSO4, FeSO4, and H3PO4 at a 1:1:2 molar ratio of manganese to iron to phosphorus dissolved in a 1:1 volumetric ratio of DI water and ethylene glycol. Solid CTAB is added to the second feed tank so the molarity of CTAB in the CSTRs will be 0.1 M. The solutions are fed into the first CSTR reactor so a 6:1:1:2 molar ratio of lithium to manganese to iron to phosphorus is maintained. The solution flows from the first to the second CSTR, then the second to the third CSTR, with a total residence time of 1 hour (approx. 20-30 minutes per CSTR). The reaction then flows into a collection tank to cool to below 100 °C until a level sensor inside the tank signals that the tank is full and activates the opening of an outlet to a slurry tank. The reaction product is agitated, then flows to a centrifugal separator. Water, ethylene glycol, and by-products are removed by the separator and LMFP product in the form of a solid, wet cake is dispensed to a collection vessel below the separator. The LMFP is spread and dried across drying trays, then placed in a continuous rotary kiln at 600 °C for 2.5 hours.

1. A continuous hydrothermal process for making lithium manganese iron phosphate (LMFP) comprising the steps:
a) providing a first reactant solution in a first feed vessel and providing a second reactant solution in a second feed vessel;
b) pumping the first reactant solution from the first feed vessel and the second reactant solution from the second feed vessel into one or more continuous stirred tank reactors (CSTRs) in series, wherein:
i) the first reactant solution comprises a lithium precursor and a carbon source in a first solvent;
ii) the second reactant solution comprises a manganese precursor, an iron precursor, and a phosphorus precursor in a second solvent;
iii) the first feed vessel and the second feed vessel are operably connected to the at least one CSTR by at least one high pressure pump, wherein, if two or more CSTRs are used each CSTR is operably connected in series; and,
iv) the first reactant solution and the second reaction solution are fed into the at least one CSTR at a molar ratio of w:x:y:z of lithium precursor to manganese precursor to iron precursor to phosphorus precursor, wherein w is 6±0.6, x is 0.1-1.9, y is 0.1-1.9, (x+y) is 2±2, and z is 2±2;
c) providing a collection tank operably connected to an exit of the CSTR or an exit of the series of CSTRs;
d) collecting a reaction product in the collection tank;
wherein, steps b), c), and d) are operated in a continuous process.

2. The process as in claim 1, further comprising the steps:
e) cooling and depressurizing the reaction product in the collection tank;
f) draining the reaction product into a slurry tank connected to an exit of the collection tank, wherein the slurry tank agitates an LMFP slurry from the reaction product;
g) feeding the LMFP slurry into a centrifugal separator connected to an exit of the slurry tank;
h) separating and removing any liquid reactor waste from the LMFP slurry, leaving only an LMFP product; and,
i) drying and sintering the LMFP product in a continuous rotary kiln;
wherein, steps b), c), d), e), f), g), and h) are operated in a continuous process.

3. The process as in claim 2, further comprising adding a surfactant to the second reactant solution.

4. The process as in claim 3, wherein the surfactant is cetyltrimethylammonium bromide (CTAB).

5. The process as in claim 4, wherein the surfactant is a sufficient amount of CTAB so the first reactant solution and the second reactant solution in the one or more CSTRs have 0.1 M CTAB.

6. The process as in claim 2, wherein the one or core CSTRs in series comprises 3 CSTRs.

7. The process as in claim 6, wherein the first reactant solution and the second reactant solution have a residence time of 1-3 hours through all 3 CSTRs.

8. The process as in claim 2, wherein the lithium precursor is LiOH, the manganese precursor is MnSO₄, the iron precursor is FeSO₄, and the phosphorus precursor is H₃PO₄.

9. The process as in claim 2, wherein the first reactant solution and the second reactant solution are flowing through the one of more CSTRs in series at a steady flowrate.

10. The process as in claim 2, wherein the carbon source is a sugar.

11. The process as in claim 10, wherein the carbon source is sucrose, and wherein the sucrose is added at a 10-20 weight % of a theoretical yield of the LFP product.

12. The process as in claim 11, wherein the carbon source is sucrose, and wherein the sucrose is added at a 15 weight % of the theoretical yield of the LFP product.

13. The process as in claim 2, further comprising purging the one of more CSTRs in series with nitrogen before step b).

14. The process as in claim 2, wherein the one or more CSTRs in series are operated at 120-220 °C.

15. The process as in claim 14, wherein the one or more CSTRs in series are operated at 180 °C.

16. The process as in claim 15, wherein the one or more CSTRs in series are operated at least 150 psig.

17. The process as in claim 15, wherein the one or more CSTRs in series are operated at least 200 psig.

18. The process as in claim 2, wherein the first solvent comprises water and the second solvent comprises ethylene glycol and water.

19. The process as in claim 18, wherein the second solvent comprises a x:y volumetric ratio of ethylene glycol to water, wherein x is 1±0.1 and y is 1±0.1.

20. The process as in claim 2, wherein the collection tank further comprises at least one level sensor on an inner side of the collection tank; and, wherein, the at least one level sensor activates step f).

21. The process as in claim 2, wherein the sintering in step i) comprises using a continuous rotary kiln to sinter the LMFP product under nitrogen, at 400-750 °C, for 2-4 hours.

22. The process as in claim 21, wherein the sintering in step i) comprises using the continuous rotary kiln to sinter the LMFP product at 600 °C for 2.5 hours.

23. The process as in claim 2, wherein the process does not comprise any ball-milling steps or any sieving steps.

24. The process as in claim 2, wherein the first reactant solution and the second reaction solution are fed into the at least one CSTR at a molar ratio of w:x:y:z of lithium precursor to manganese precursor to iron precursor to phosphorus precursor, wherein w is 6±0.3, x is 0.1-1.9, y is 0.1-1.9, (x+y) is 2±0.1, and z is 2±0.1.

25. The process as in claim 24, wherein the first reactant solution and the second reaction solution are fed into the at least one CSTR at a molar ratio of w:x:y:z of lithium precursor to manganese precursor to iron precursor to phosphorus precursor, wherein w is 6±0.06, x is 0.1-1.9, y is 0.1-1.9, (x+y) is 2±0.02, and z is 2±0.02.
